(19) United States
(12) Patent Application Publication
(10) Pub. No.: US 2019/0336925 A1
(43) Pub. Date: Nov. 7, 2019

(54) MIXING CUP WITH PINS FOR AN ASYMMETRIC ROTATION MIXER

(71) Applicant: FLACKTEK, INC., Landrum, SC (US)

(72) Inventors: Ian Thomas LAROSE, Greenville, SC (US); Michael Shane GREEN, Cardiff, CA (US); Matthew L. GROSS, Boulder, CO (US)

(21) Appl. No.: 16/402,937

(22) Filed: May 3, 2019

Related U.S. Application Data
(60) Provisional application No. 62/666,280, filed on May 3, 2018.

(51) Int. Cl. B01F 9/00

(52) U.S. Cl. CPC B01F 9/0034; B01F 2009/009; B01F 9/0014

(57) ABSTRACT

A mixing container for a mixer, the container comprising, in exemplar embodiments, a cup and a lid, in which the lid has at least two sets of closely-spaced pins projecting therefrom. The sets of pins are spaced generally equidistant from each other and provide increased shearing of fluids or particulate matter being mixed within the cup.

### PRIORITY CLAIM

This application claims priority to co-pending U.S. Provisional Patent Application No. 62/666,280, filed May 3, 2018, entitled MIXING CUP WITH PINS FOR AN ASYMMETRIC ROTATION MIXER, the disclosure of which is incorporated by reference herein in its entirety.

### FIELD

The present disclosure relates generally to devices and methods of mixing. More specifically, the present disclosure relates to devices and methods for mixing fluids, semi-fluids, gels, particles, powders, and other flowable material.

### BACKGROUND

Dynamic mixing can include agitation of substances without invasive mixer components extending into the substance, such as stirring rods. Rotational mixers can include a rotation and/or oscillation component to assist in mixing the substances. Appropriate geometries for effective and efficient mixing can depend on process variables.

### SUMMARY

According to an aspect of the present disclosure, a mixing container for a rotational mixer includes a cup, a lid adapted to be fitted on the cup, and a plurality of pins extending from the lid into the cup. The cup includes a bottom, a side wall, and a rim at an opposite end of the side wall from the bottom. The lid is adapted to be fitted with the rim to hold the lid on the cup.

In illustrative embodiments, the plurality of pins includes at least one set of pins associated. The pins are generally parallel and spaced close together. The set of pins is adapted to provide increased shearing force to a material to be mixed when the mixing container is rotated about an internal axis.

In illustrative embodiments, mixing container further includes a ring adapted to be associated with the lid. The ring has a plurality of pin-receiving means associated therewith. Each pin receiving means is adapted to retain a portion of each pin.

In illustrative embodiments, the at least one set of pins comprises three sets of pins. Each set of pins is equidistantly spaced from each other.

### BRIEF DESCRIPTION OF THE DRAWINGS

The drawings disclose exemplary embodiments in which like reference characters designate the same or similar parts throughout the figures of which:

FIG. 1 is a perspective view of an asymmetric rotation mixer including a receptacle for holding a mixing container.

FIG. 2 is a partially exploded perspective schematic view of one exemplary embodiment of a mixing container according to the present disclosure, showing a cup and lid.

FIG. 3 is a bottom perspective view of one exemplary embodiment of a lid with an attachment member, to which are attached three sets of pins.

FIG. 4 is a side perspective view of the exemplary embodiment of FIG. 3.

FIG. 5A is a side elevational view of one exemplary embodiment of a pin tapering from proximal end to distal end.

FIG. 5B is a side elevational view of one exemplary embodiment of a pin tapering from distal end to proximal end.

FIG. 5C is a side elevational view of one exemplary embodiment of a pin having surface protrusions.

FIG. 6 is a side elevational view of an exemplary embodiment showing a lid having a first ring and a second ring.

FIG. 7 is a side elevational view of the exemplary embodiment of FIG. 8 and showing the lid on a cup.

FIG. 8 is a side elevational view of an exemplary embodiment showing a lid having three sets of pins associated therewith.

FIG. 9 is a side elevational view of the exemplary embodiment of FIG. 8 and showing the lid on a cup.

FIG. 10 is a side elevational view of an exemplary embodiment in which the lid has sets of pins associated therewith and the cup also has sets of pins associated therewith.

FIG. 11 is a side elevational view in which each set of pins comprises three pins.

FIG. 12 is a bottom view of an exemplary embodiment of a lid having three sets of pins with each set arranged collinearly.

FIG. 13 is a bottom view of an exemplary embodiment of a lid having three sets of pins with each set arranged in a triangle.

FIG. 14 is a side elevational view of an exemplary embodiment in which the pins are associated with the cup bottom.

### DETAILED DESCRIPTION

Unless otherwise indicated, the drawings are intended to be read (for example, cross-hatching, arrangement of parts, proportion, degree, or the like) together with the specification, and are to be considered a portion of the entire written description of this invention. As used in the following description, the terms “horizontal”, “vertical”, “left”, “right”, “up” and “down”, “upper” and “lower” as well as adjectival and adverbial derivatives thereof (for example, “horizontally”, “upwardly”, or the like), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate

For the purposes of promoting an understanding of the principles of the disclosure, reference will now be made to a number of illustrative embodiments illustrated in the drawings and specific language will be used to describe the same.

Dynamic mixing, such as rotation mixing, can provide effective, non-invasive mixing of substances or formulations. Asymmetric rotation mixing can be particularly fast and effective by imposing centrifugal (centripetal) force on the substance(s) to be mixed. Various containers can be selected for containing the substance(s) to be mixed and undergoing the asymmetric rotation. Substances or formulations that can be mixed using the presently disclosed invention include, but are not limited to, fluids, semi-fluids, suspensions, colloids, gels, pastes, articles, granules, powders, other flowable material, and mixtures or combinations of at least two of the foregoing. Examples of materials that can be mixed include, but are not limited to, creams to be formulated with medicinal material, as well as epoxies, inks, adhesives, sealants, and coatings.

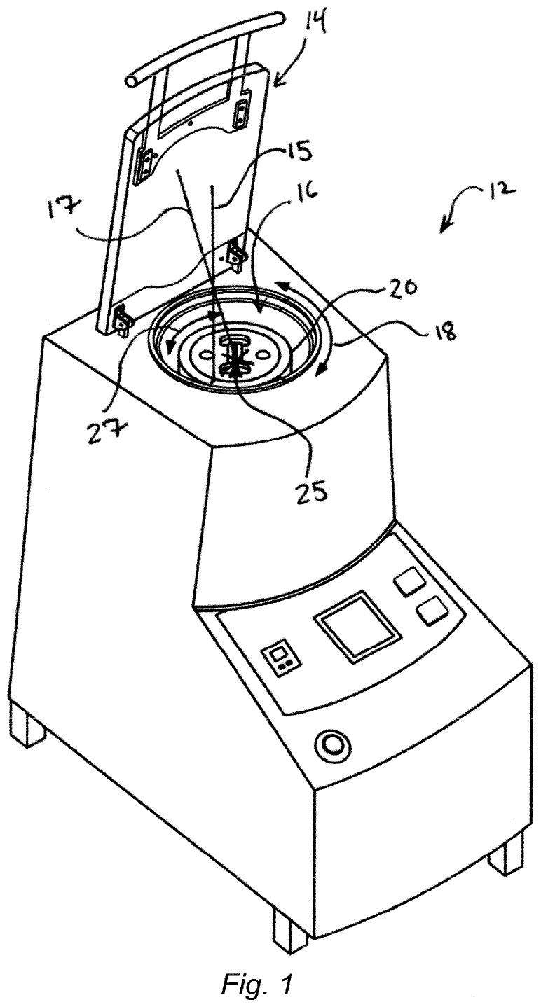

In the illustrative embodiment as shown in FIG. 1, an asymmetric rotation mixer 12 having its hatch (door) 14 open to reveal a mixing chamber 16 for conducting asymmetric rotation mixing is shown. The chamber 16 can receive a mixing container 20 that contains one or more substances for rotational mixing. In some embodiments, the mixing container 20 is received in a basket of the mixer 12 for supporting the mixing container 20 during rotation. The mixing container 20 can be engaged with a rotation drive (not shown) of the mixer 12 that imposes rotational forces on the mixing container 20 engaged with the chamber 16. It is to be understood that other types of mixers other than an asymmetric rotation mixer can be used with the mixing container of the present disclosure.

In the illustrative embodiment as shown in FIG. 1, the mixer 12 is embodied as a dual axis rotation mixer. The mixer 12 illustratively rotates (or revolves; as indicated by arrows 18) the mixing container 20 about a primary axis 15 while simultaneously rotating the mixing container 20 itself about a secondary axis 17 (as indicated by arrows 27). The secondary axis 17 is illustratively defined through a centroid 25 (or center of mass) of the mixing container 20. The primary axis 15 is offset from the centroid 25 for asymmetric rotation of the mixing container 20 (as indicated by arrows 27).

Examples of suitable rotational mixers 12 can be found within U.S. Pat. Nos. 6,099,160 and 6,755,565, the disclosures of each of which are incorporated by reference herein in their entireties. Such dual axis rotation mixing including asymmetric rotation may be referred to as planetary mixing and/or centrifugal mixing, although these terms may not be entirely accurate and are not intended to limit mixing parameters such as the direction of rotation about each of the dual axes, speed, and/or other geometry relationships.

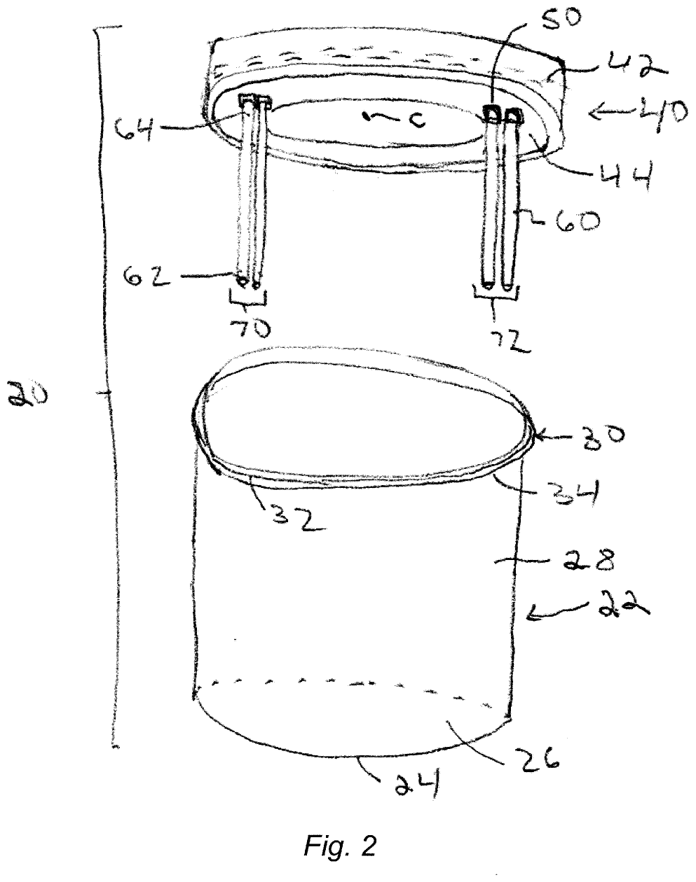

Referring to FIG. 2, one exemplary embodiment of a mixing container 20 is shown. The container 20 has mixing cup 22 having a bottom 24, interior bottom surface 26, side 28, and rim 30. In exemplary embodiments, the rim 30 may have threads 32 formed therein or thereon (illustratively shown on the outside of the side 28, but which alternatively could be on the inside of the side 28). In exemplary embodiments the rim 30 may additionally or alternatively have a flange 34. In exemplary embodiments, the mixing container 20 may also include a removable lid 40.

In exemplary embodiments, the lid 40 is adapted to fit on the cup 22 proximate to the rim 30. In exemplary embodiments, the lid 40 matingly fits over the rim 30, such as by friction fit, mating threads, snap fit, attached by grommets or bolts, or other attachment means known to those skilled in the art. In an alternative exemplary embodiment, the lid 40 fits inside the cup 22. In one exemplary embodiment the lid 40 has internal threads 42 (or external threads, depending on whether the cup 22 has internal threads), which can matingly attach to the threads 32 of the rim 30 to sealingly close the cup 22. In exemplary embodiments, it is desirable that the fit be substantially leak-free so that material to be mixed does not escape the container 20 during mixing, and so that air does not enter the container 20.

In exemplary embodiments, the cup 22 is formed of plastic. In exemplary embodiments, the cup may be made of any generally rigid and inert material that is able to withstand the rotational forces during mixing, for example, polypropylene, polyethylene, polystyrene, polyurethane, tin, aluminum, steel, silicon dioxide, mixtures and combinations of the foregoing, and the like. In exemplary embodiments, the volume of substance within the container is within the range of about 0.1 ml to about 20000 ml. In exemplary embodiments, the lid 40 is formed of the same material as the cup 22. In other exemplary embodiments, the lid 40 is formed of a material different than the material from which the cup 22 is formed. In exemplary embodiments, the lid 40 may optionally have at least one opening defined therein (not shown) for relief of air (or other gas) pressure that may build up during mixing.

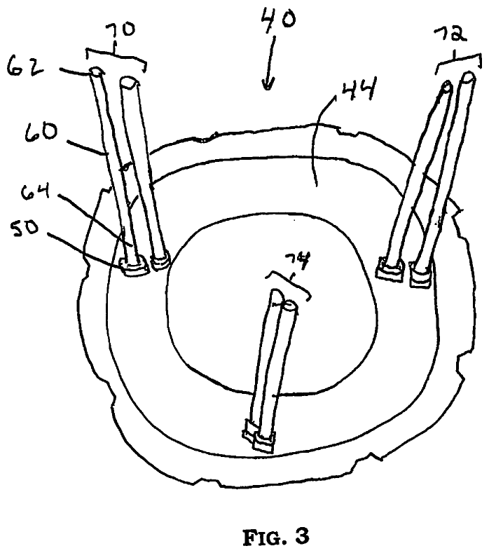

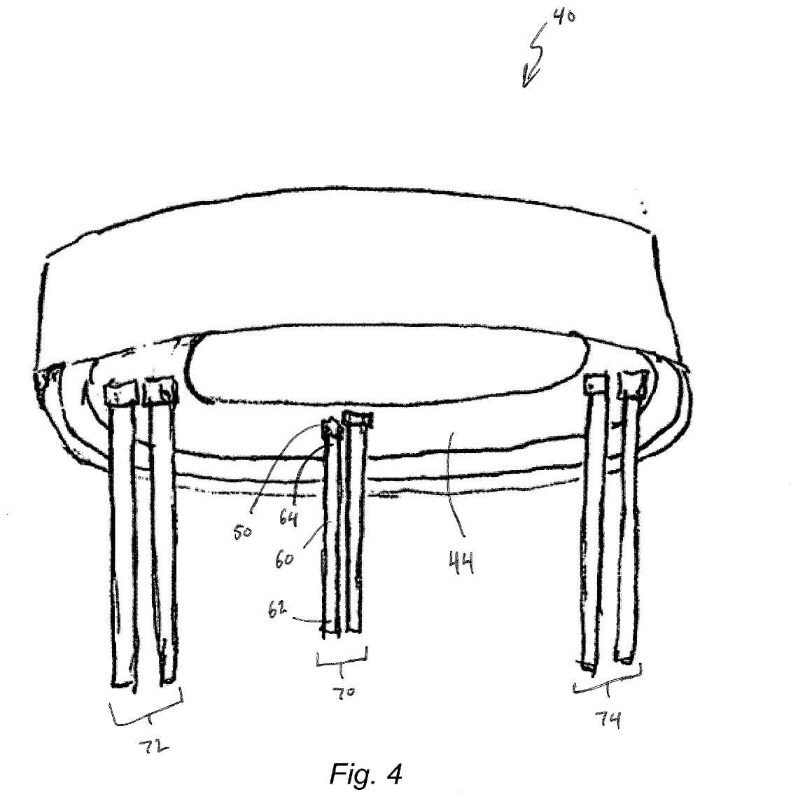

Referring to FIGS. 2-4, an exemplary embodiment of a mixing container 20 includes an attachment member 44. In one exemplary embodiment, as shown in FIG. 2, the attachment member comprises a ring 44. The ring 44 may be made of metal, plastic or other generally rigid material. In exemplary embodiments, the ring 44 has several pin-receiving means 50 associated therewith. In exemplary embodiments, the pin-receiving means 50 can be a recess or aperture in the ring 44. In one exemplary embodiment, the pin-receiving means 50 extends through the ring 44. In other exemplary embodiments the pin-receiving means 50 can be a recess in (but not extending all the way through) the interior surface of the ring 44. As shown in FIG. 3, in exemplary embodiments, the pin-receiving means 50 can be a lug, boss, protrusion, or other structure extending from or attached to the surface of the ring 44 and which has a hollow or recessed area adapted to receive a pin. Each pin-receiving means 50 has a pin 60 associated therewith. In exemplary embodiments, the pin 60 has a distal end 62, and a proximal (relative to the surface to which it is associated) end 64 that is force fit, screw-threaded, welded, attached using an adhesive, or otherwise associated with the aperture. In an alternative exemplary embodiment, the pin 60 may be formed as part of, and extending from, the ring 44.

In exemplary embodiments, instead of a ring, the attachment member may be a generally circular plate. A ring may provide advantages of less material and less weight, while a circular plate may provide increased stiffness and strength to the lid. For the purposes of the present disclosure, a ring may be described in connection with certain embodiments, it being understood that such ring is only one type of attachment member, and a ring or other structure is also contemplated as being suitable. Furthermore, in exemplary embodiments an attachment member is not required and the pins can be directly attached to the lid.

In exemplary embodiments, the pin 60 is made of a generally rigid material, such as, but not limited to, metal, ceramic, plastic, polymer, wood, mixtures and combinations of the foregoing, or the like. In exemplary embodiments the two pins in a given set may be made of different materials. In exemplary embodiments the cross-sectional shape of the pin is round. In other exemplary embodiments, the cross-sectional shape may be square, triangular, elliptical, oval, or other regular or irregular shape. In some embodiments, the pins 60 can be arranged in sets, such as set 70, 72 shown in FIG. 2. In some embodiments, more sets of pins are used, such as sets 70, 72, 74 as shown in FIG. 3. In some embodiments, even more sets are used. Each set can include two or more pins 60 arranged adjacent to one another. In some embodiments, the pins 60 are arranged in a pattern, including, but not limited to, geometric, symmetric, asymmetric, and other patterns. The sets of pins 60 may be evenly or unevenly spaced relative to one another.

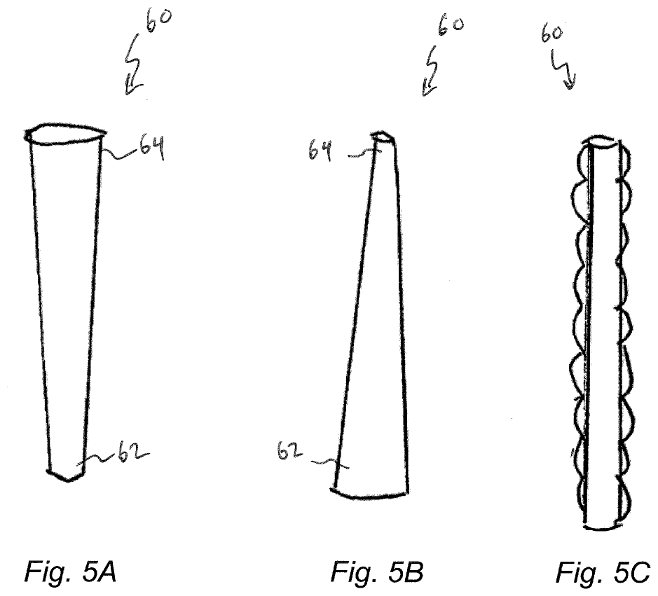

In other exemplary embodiments, illustrated in FIGS. 5A-C, the pin 60 may have a diameter that tapers from the proximal end to the distal end. In another exemplary embodiment, the pin 60 may have a diameter that tapers from the distal end to the proximal end. In other exemplary embodiments the pin diameter may vary in a regular or irregular way from the proximal end to the distal end. In exemplary embodiments the surface of the pin 60 may be generally smooth. In other exemplary embodiments, the surface of the pin 60 (or at least a portion thereof) may have regular or irregular appearance, such as, but not limited to, including grooves or ridges, ribs, bumps, teeth or other regular or irregular-shaped protrusions, such as shown in FIG. 5C. In exemplary embodiments, each pin in a set has the same shape. In other exemplary embodiments each pin (or two or more pins) in a set may have a different surface appearance.

In exemplary embodiments the pin 60 is attached to the ring 44, such as, but not limited to, by having a threaded internal bore in the ring 44 into which a bolt can be threaded, with the ring 44 being between the pin 60 and the bolt. In another exemplary embodiment, the ring 44 may have a raised receptacle, such as, but not limited to, a lug or a boss, into which a portion of the pin 60 can be inserted and retained. In one exemplary embodiment the ring 44 is associated with the lid 40, such as by snap fit, friction fit, adhesive, or other attaching means. In exemplary embodiments the ring 44 is removable from the lid 40. In other exemplary embodiments, the ring 44 is fixedly attached to the lid 40. In an alternative exemplary embodiment, the ring 44 is associated with the bottom 24 (rather than the lid 40), such as by snap fit, friction fit, adhesive, or other attachment means.

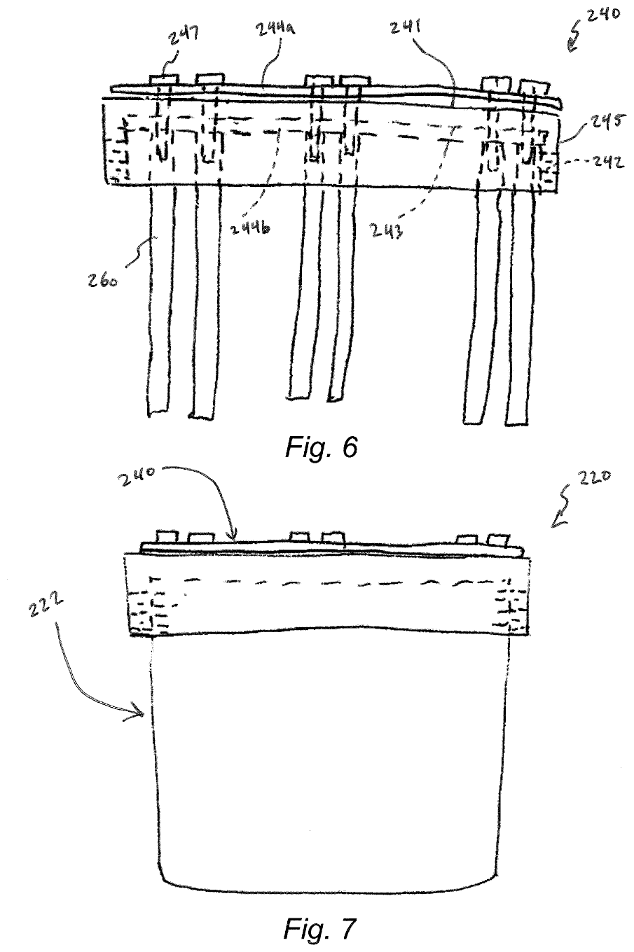

Referring to FIGS. 6-7, an exemplary embodiment is shown in which a lid 240 has top side 241 and a bottom side 243. The lid 240 has a rim 245 that, in exemplary embodiments, may include threads 242 in the interior wall. A first ring 244a is attached to the top side 241 and a second ring 244b is attached to the bottom side 243. Each of the first ring, second ring, and lid has apertures through which a screw, bolt or other fastener 247 can pass. The fastener may have threads. Each pin 260 can be attached to the lid by a fastener that extends through the aperture in the top ring, the lid, and the bottom ring and is received within a bore in the pin. In exemplary embodiments, the pin bore is threaded to matingly receive a portion of the threaded fastener. In this embodiment, a relatively thin lid can be strengthened by the two rings to be able to adequately hold the pins in place during mixing. The lid, having the rings and pins associated therewith, can be fitted on the cup 222, such as by the threads, to form mixing container 220.

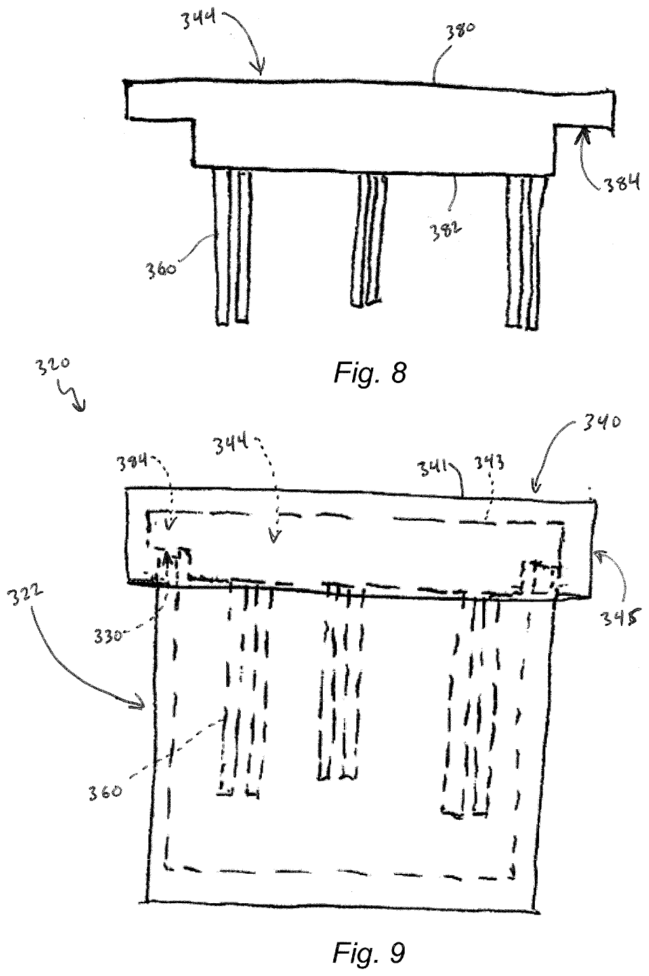

Referring to FIGS. 8-9, an exemplary embodiment is shown in which a lid 340 has a top side 341 and a bottom side 343. The lid 340 has a rim 345 that, in exemplary embodiments, may include threads in the interior wall. An attachment member 344 comprises a generally circular cross-sectional shaped ring or plate having a top side 380, bottom side 382, and a lip portion 384. The sets of pins 360 can be attached to the attachment member 344 so as to extend from the bottom side 382. Attachment may be done by any of the various means described herein. To assemble, the pins 360 are attached to the attachment member 344. The attachment member 344 is placed on top of the cup 322 with the lip 384 resting on top of the cup rim 330 so that the pins 360 are disposed inside the cup 322. The lid 340 can then be screwed on (or otherwise attached to) the cup 322. A feature of this embodiment is that the cup and lid can be industry standard parts, and the attachment member can be designed appropriately so that it rests on the cup rim.

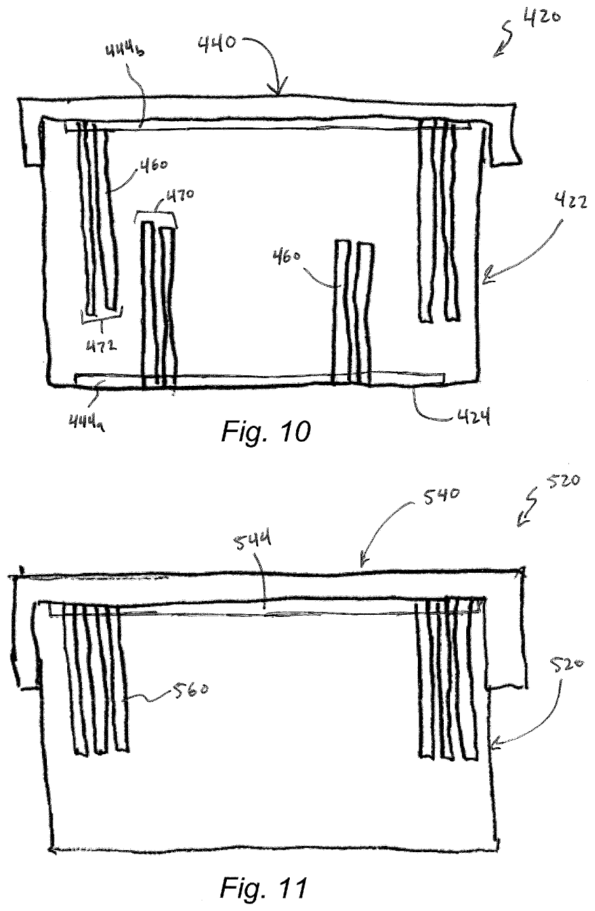

In an alternative exemplary embodiment, shown in FIG. 10, a mixing container 420 has a cup bottom 424 having associated with it a first ring 444a having two or more sets of pins 460 associated therewith, and a lid 440 having a second ring 444b having two or more sets of pins 460 associated therewith, whereby when the lid is attached to the cup 422, the sets of pins 460 of the first ring are spaced generally equidistantly apart from the sets of pins 460 of the second ring. In exemplary embodiments, the sets of pins 460 associated with the first ring may be spaced from a centerpoint of the lid at a first distance, while the sets of pins 460 associated with the second ring may be spaced from the centerpoint of the lid at a second distance. In exemplary embodiments, the first distance may equal the second distance. In exemplary embodiments, the first distance may be different than the second distance.

In the exemplary embodiment shown in FIG. 10, a first of pins 470 is located opposite from a second set of pins 472 (i.e., in a line collinear with the centerpoint C of the lid 440) so that, when the container 420 is spun the sets of pins 470, 472 do not create any undesired vibrations).

In exemplary embodiments, the pins of a given set are located close to each other. In one exemplary embodiment, the pins in a given set are less than about ¼ inches apart. The narrow spacing of each pin in a set is based on generating higher shearing force as the material is mixed while the container rotates. The spacing of the pins in a set can be designed to optimize the mixing for a given material that is to be mixed. In exemplary embodiments the spacing between the two pins in a given set of pins is the same. In exemplary embodiments the spacing between the two pins in a first set of pins is different than the spacing between a second set of pins. In exemplary embodiments in which three or more sets of pins are utilized, each set may have a distinct spacing distance between the pins; i.e., the spacing between the pins does not have to be equal.

Referring to FIG. 11, an alternative exemplary embodiment of a container 520 is shown, having a cup 522 and a lid 540 and a ring 544 having pins 560 associated therewith. In this embodiment, pins 560 are formed as a set of three, and, in exemplary embodiments, are disposed generally equidistant from each other, e.g., at about 120 degrees.

In another exemplary embodiment, four or more sets of pins can be used.

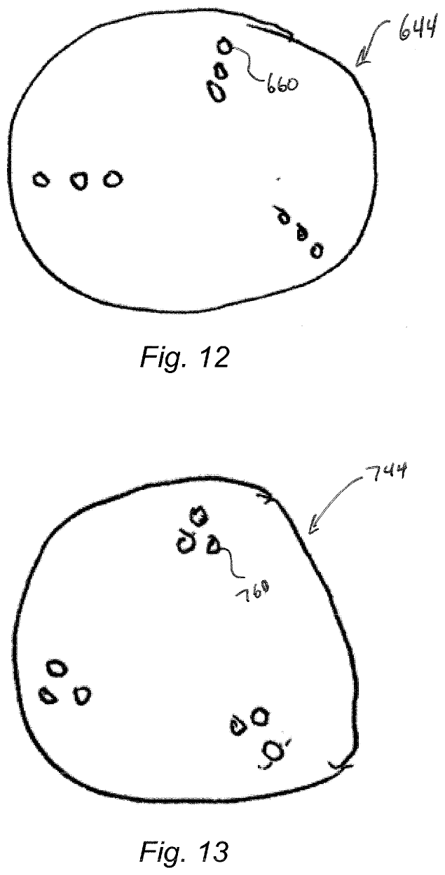

Referring to FIG. 12, in yet another exemplary embodiment the pins 660 can be arranged with each set comprising three pins, with all three pins being collinear on the attachment member 644. In an alternative embodiment, shown in FIG. 13, the pins 760 can be equidistant from each other (i.e., in generally a triangle shape), or can be spaced differently on the attachment member 744. In another exemplary embodiment, the pins can be arranged with each set comprising four pins, with all the pins being collinear. In an alternative embodiment the four pins can be equidistant from each other (i.e., in generally a square shape), or can be spaced differently. In other exemplary embodiments each set of pins may comprise more than four pins.

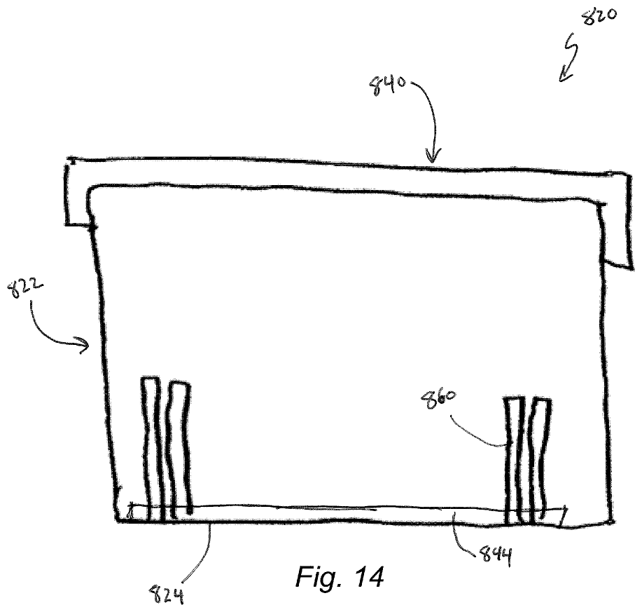

Referring to FIG. 14, an exemplary embodiment of a container 820 is shown, having a cup 822, having a bottom 824, and a lid 840. Pins 860 are associated with the cup bottom 824 by one of the means described hereinabove in various embodiments, such as an attachment member 844.

In operation, the container 20 (or any of the various embodiments thereof) is charged with the material or materials to be mixed. The lid 40 is then attached to the container and the container is placed in the mixer chamber 16. The motor is activated and the container 20 spins within the chamber 16. The pins 60 promote the mixing of the material in the container 20 by causing shearing of the mixing material as the material passes between and around the sets of pins. The close spacing of the pins 60 increases the shearing force and improves the thoroughness of the mixing and the uniformity of the resulting mixture.

The variations and benefits of each embodiment described herein are equally applicable to the other embodiments described herein, and any combinations therebetween are fully contemplated by this disclosure.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

Claimed is:

1. A mixing container for a rotational mixer, the container comprising:
a. cup having a bottom, a wall, and a rim;
b. a lid adapted to be fitted with the rim; and,
c. at least one set of pins associated with the lid, the pins being generally parallel and spaced close together and adapted to provide increased shearing force to a material to be mixed when the mixing container is rotated about an internal axis.

2. The mixing container of claim 1, wherein the mixing container further comprises a ring adapted to be associated with the lid, the ring having a plurality of pin-receiving means associated therewith, each pin receiving means being adapted to retain a portion of each pin.

3. The mixing container of claim 1, wherein the at least one set of pins comprises three sets of pins, each set being equidistantly spaced from each other.
